(19) United States
(12) Patent Application Publication
(10) Pub. No.: US 2011/0162501 A1
(43) Pub. Date: Jul. 7, 2011

(54) DUST EXTRACTION BLADE GUARD SYSTEM FOR POWER SAWS

(75) Inventors: Jan Koegel, Arlington Heights, IL (US); Howard Chen, Barrington, IL (US)

(73) Assignees: CREDO TECHNOLOGY CORPORATION, Broadview, IL (US); ROBERT BOSCH GMBH, Stuttgart (DE)

(21) Appl. No.: 12/652,990

(22) Filed: Jan. 6, 2010

(51) Int. Cl. B27G 19/02; B27G 19/08; B26D 7/18

(52) U.S. Cl. 83/100; 83/102.1; 83/478

(57) ABSTRACT

Embodiments of the invention are directed a guard system for a table saw having a top surface with an opening through which a blade extends for cutting a work piece, the forward reach of the cutting edge of the blade engaging the work piece in a downward cutting direction, the system comprising an upper guard mounted to the table saw and configured to enclose the blade to shield a user from contacting the blade, the upper guard having an outlet adjacent the rearward reach of the blade for connection to a vacuum source, an inlet adjacent to the forward reach of the blade and to the table top surface and an interior channel communicating the inlet to the outlet.

### BACKGROUND OF THE INVENTION

The present invention generally relates to dust control systems for power tools. Safety of users of power tools, such as table saws, miter saws and the like have been the concern of manufacturers and others for decades and continues to drive research and development to minimize the potential for harm and other health risks of users of such equipment. It is well known that miter saws and table saws have been provided with blade guards to protect a user from being injured during use.

Such power saws are also provided with various types of dust control systems that can be connected to a source of vacuum for the purpose of removing dust during their operation. While dust control systems for such tools have been in use for many years, their effectiveness and efficiency is often less than desirable for several reasons. One reason is that many dust control systems require a separate source of vacuum that is not typically sold with the tool itself. Therefore, the design of the tool may not be optimized for efficient dust control because the dust control aspect of it is not a focus of marketability of the tool itself. Other designs may have dust removal capabilities that use a fan blade driven by the motor of the saw itself which may not provide sufficient air movement for effective and efficient dust extraction. Cost considerations may also affect the design of a dust distraction system and as a result, does not provide the necessary air flow at a location on the saw where most of the dust is generated, which is usually at or very near the point of initial contact between the cutting blade or tool and the work piece being cut or machined.

### SUMMARY OF THE INVENTION

Embodiments of the invention are directed a guard system for a table saw having a top surface with an opening through which a blade extends for cutting a work piece, the forward reach of the cutting edge of the blade engaging the work piece in a downward cutting direction, the system comprising an upper guard mounted to the table saw and configured to enclose the blade to shield a user from contacting the blade, the upper guard having an outlet adjacent the rearward reach of the blade for connection to a vacuum source, an inlet adjacent to the forward reach of the blade and to the table top surface and an interior channel communicating the inlet to the outlet.

Other embodiments further comprise a lower guard mounted to said table saw beneath the table top surface and that is configured to enclose the lower reaches of the blade and receive saw dust and particles from a work piece being cut, wherein the lower guard has an outlet adjacent the rearward reach of the blade for connection to a vacuum source.

### DESCRIPTION OF THE DRAWINGS

FIG. 1 is a front left upper perspective view of a dust extraction blade guard system shown in conjunction with a riving knife, cutting blade and table top shown in phantom;

FIG. 2 is a perspective view similar to FIG. 1 illustrating only the upper and lower blade guard of the system shown in FIG. 1;

FIG. 3 is a side view of the system shown in FIG. 1;

FIG. 4 is a cross sectional view taken along the line 4-4 of FIG. 3;

FIG. 5 is a cross section taken generally along the line 5-5 of FIG. 3;

FIG. 6 is a left front elevated perspective view of a second preferred embodiment together with a table top (shown in phantom) and a work piece; and

FIGS. 7 and 8 are cross sections taken generally along the line 7-7 in FIG. 6, with FIG. 8 showing a work piece in a cutting position and the side plates in a raised position.

### DETAILED DESCRIPTION

The present invention is directed to a dust extraction system for power tools, such as table saws and miter saws, for example. Embodiments of the present invention are directed to upper and lower blade guards that provide the dual functionality of protecting a user from inadvertently contacting a saw blade during use and also to extract dust that is generated during a cutting operation. While there are upper guards for table and miter saws that are also configured to provide dust extraction, most of them are not sufficiently efficient to provide dust extraction at the front end of the guard where most of the diffusion dust is developed by the initial engagement of a saw blade with a work piece.

Known guards for table saws that are also designed for dust extraction are relatively inefficient because they are comprised of a single shell with a rear outlet where the suction force is effectively applied generally rearwardly of the rear reach of the cutting blade and is therefore comparable to an inefficient open system.

The embodiments of the dust extraction system of the present invention are substantially closed guard systems that function to extract dust at the areas where the dust originates. The systems have an upper blade guard that utilizes an internal channel that extends from the rear of the guard to the front reach of the saw blade where the work piece is initially contacted. The preferred embodiments have an upper guard as well as a lower guard, wherein the upper guard consists of a cover guard as well as a base guard, with the two guard components creating a primary channel or chamber which defines a flow path for extracting diffusion dust as well as chips and/or splinters that may be generated at the front end of the guard and front reach of the blade. Both the upper guard and lower guard have an outlet for attachment to a hose or the like of a vacuum source.

In addition to the inlet in the front end of the upper guard which has the primary channel that extends to the outlet, slots are also provided on the bottom surface along the sides of the upper guard and space between the base guard and cover guard create a secondary channel that merges with the primary channel.

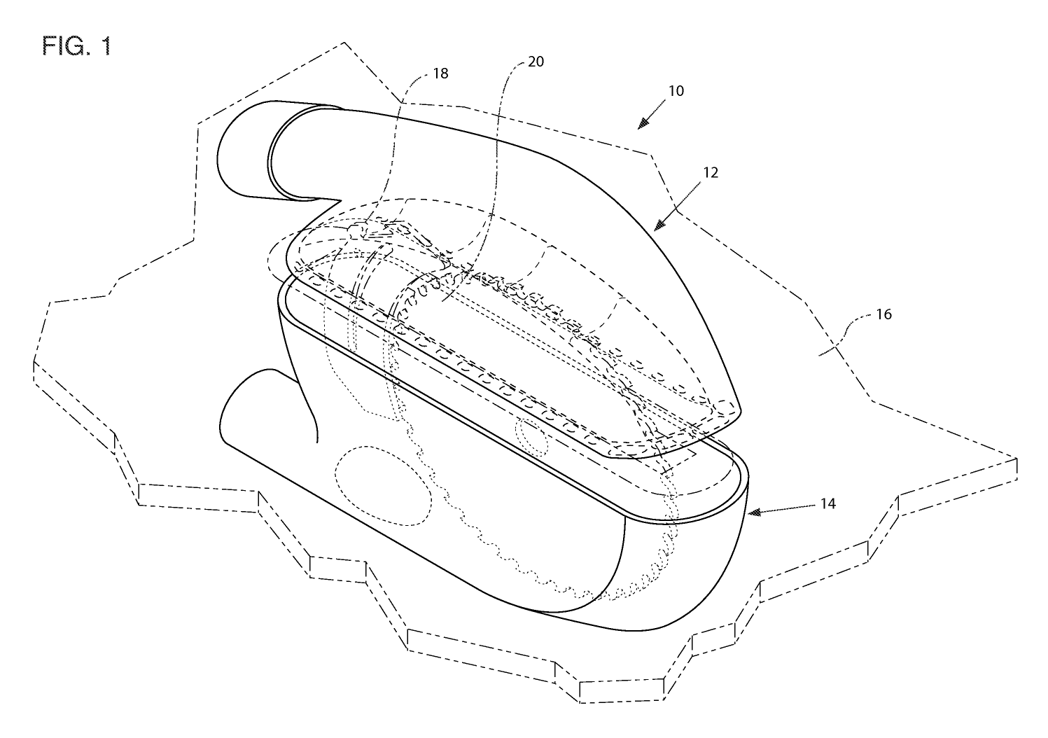

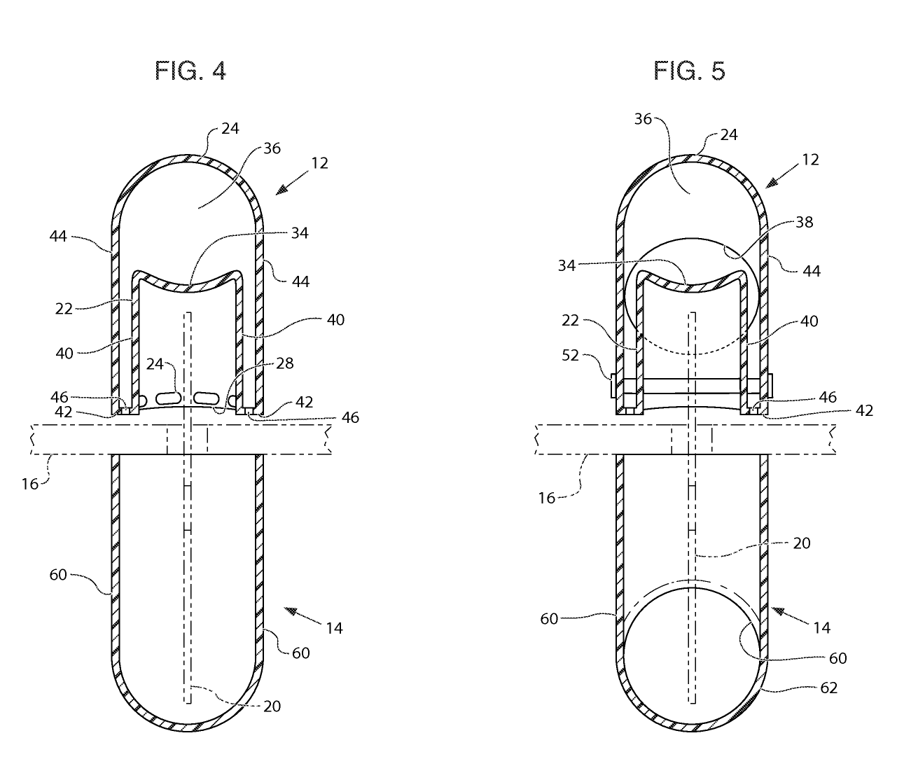

Turning now to the drawings, and particularly FIGS. 1-5, a dust extraction system, indicated generally at 10, includes an upper blade guard, indicated generally at 12, as well as a lower blade guard, indicated generally at 14. The blade guard system 10 is shown in FIG. 1 in conjunction with a table top 16, a riving knife 18 and a blade 20, the latter three components being shown in phantom. While the system 10 is particularly configured for use with a table saw, it can be modified for use with other types of cutting and sawing equipment that could be used with a vacuum system where dust and debris are generated at a particular location.

The system 10 that is shown and described in FIGS. 1-5, is directed to a closed guard system that extracts dust in the areas where the dust originates. In this regard, the system has extraction capability that originates at the front end of a guard where the saw blade initially contacts the work piece that is being cut. The upper guard 12 is comprised of an interior base guard portion 22 and an outer cover guard portion 24. Both guard portions are preferably fabricated from a relatively thin but strong transparent plastic or plastic-like material. The transparency has a desirable effect of enabling a user to see the saw blade 20 and the portion of the work piece that is being cut. It may also be useful in enabling a user to determine the effectiveness of the dust extraction during a cutting operation.

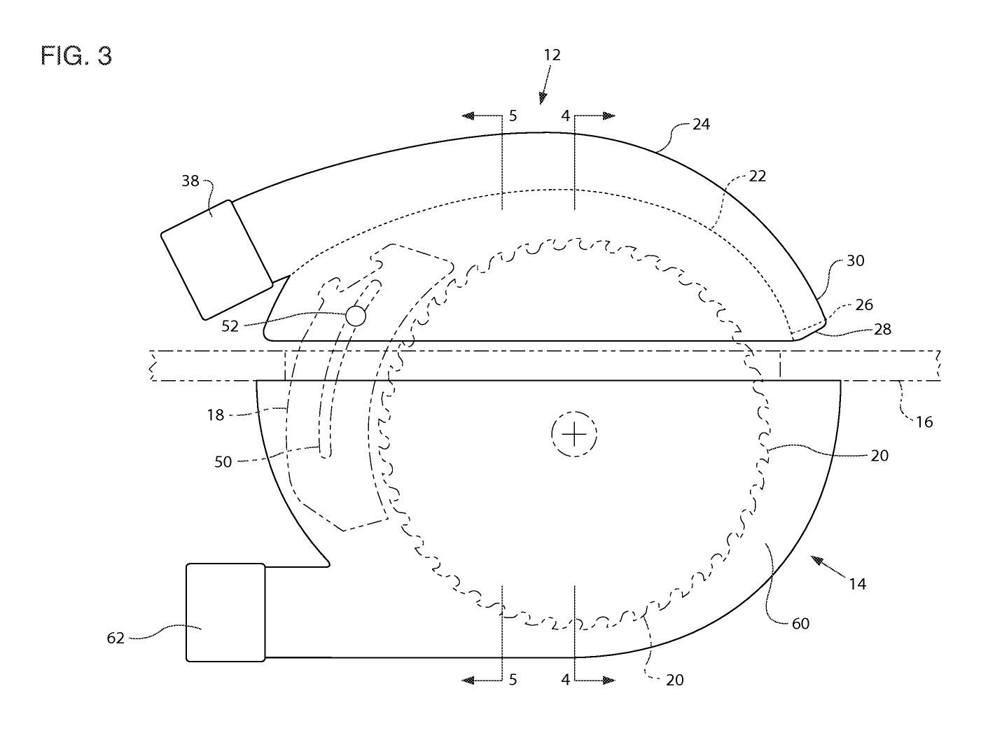

The base guard portion 22 and cover guard portion 24 are connected together, but are spaced from one another along the sides, front and top thereof to create the primary and secondary flow paths that enable a suction force to remove dust that may be collected from the area near the blade 20. In this regard, the spacing between the base and cover guard portions is significantly smaller than at the top and front thereof. More specifically, and referring to FIGS. 3, 4 and 5, the top surface of the base guard portion extends from a front end 26 that terminates in an inclined end face 28 that also merges with a front portion 30 of the cover guard 24.

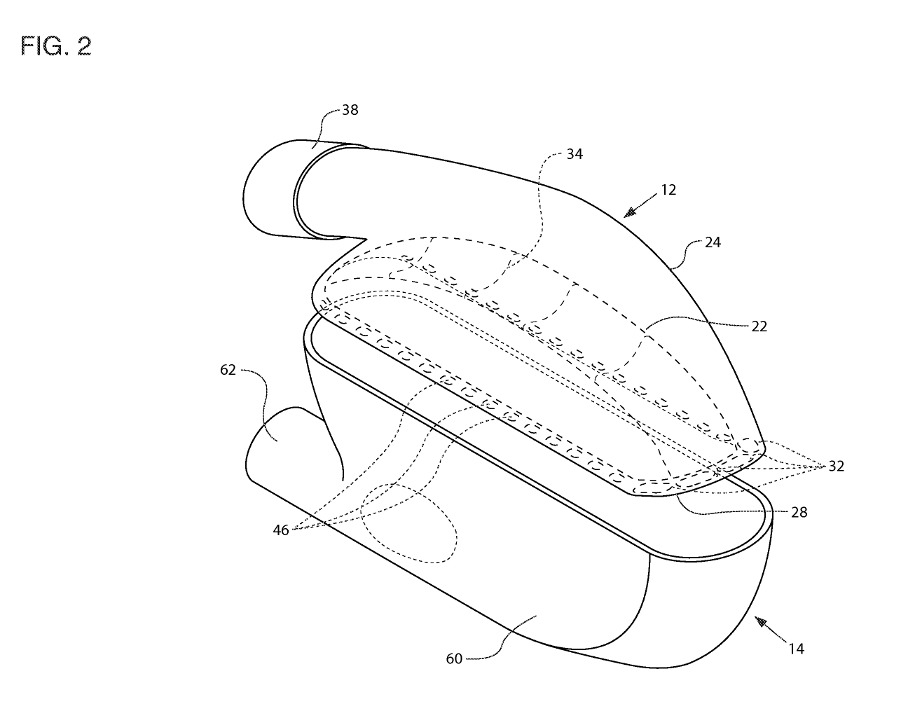

The end face 28 has a number of inlets 32 which are located near the front reach of the blade 20 in position to have the vacuum force pull in diffusion dust as well as other larger particles that are generated by the cutting action of the blade on a work piece. The base guard portion extends from the front surface 26 upwardly to a top portion 34 thereof, which as is shown in FIGS. 2, 4 and 5, is generally concave so as to define an interior channel 36 which provides a flow path to an outlet 38 that is preferably cylindrical in shape to be coupled to a flexible tube that extends to a source of vacuum (not shown).

The base guard portion 22 has sidewalls 40 which extend from the top portion 34 to a bottom surface 42 which merges with sidewalls 44 of the cover guard portion 24. As is best shown in FIGS. 1, 2 and 4, the bottom wall 42 has a number of smaller slots 46 positioned along the sides of the system 10 that are configured to draw in air for extracting dust that is generated but which is not extracted through the front openings 32. The space between the inner and outer walls 40 and 44 provides a secondary flow path for extraction, which merges with the primary channel 36.

It should be understood that the relative size of the openings 46 and 32, as well as the primary channel 36 and the secondary flow paths between the walls 40 and 44 can be configured to maximize the efficiency of the overall system, but it is preferred that the openings 32 at the front inclined face 28 be relatively larger than the openings 46 along the sides of the upper blade guard 12 so that maximum vacuum force is applied to the front of the upper blade guard 12 because the majority of the diffusion dust as well as particulate matter is generated by the saw blade engaging the work piece at the front reach of the saw blade.

It should also be understood that while the inclined end face 28 is angled as shown, it may be coplanar with the bottom surface 42 if desired. Moreover, it could be extended at the same angle but extended rearwardly to provide a larger inclined surface that a work piece could engage to pivot the blade guard 12 upwardly so that the work piece could move underneath the upper blade guard during a cutting operation. Alternatively, other embodiments could have a separate extension angled forwardly to engage a work piece for this purpose. In that event it may be made of metal or the like that is attached to the upper blade guard 12.

Referring to FIG. 3, the riving knife 18 has a slot 50 provided for the dual purpose of adjustably mounting the riving knife 18 to a component of the table saw, and also to provide a pivot connection to the upper blade guard 12. In this regard, a pivot connection 52 is provided that extends through both sidewalls 40 and 44 and engages the slot 50 of the riving knife. While the connector 52 is diagrammatically shown, it should be understood that it is preferably a quick connection type of connection so that the upper blade guard can be easily and quickly separated from the riving knife 18. Moreover, the connector enables the upper blade guard 12 to be pivoted around the connector 52 and also can be slidable in the slot 50 so as to enable it to be vertically moved by an amount required by the thickness of a work piece that is being cut. While the configuration of the riving knife 18 shown in FIGS. 1 and 3 would not permit a considerable amount of vertical movement of the upper blade guard 12, it should be understood that the riving knife 18 can be adjusted upwardly relative to the mounting mechanism of the table saw.

It should also be understood that the upper blade guard can be attached to an independent structure located above the table top, appropriately mounted to a crank arm or other structure associated with the table saw, rather than being mounted on the riving knife 18.

The lower blade guard 14 is shown to have a general configuration similar to the upper blade guard 12, and has sidewalls 60 and a cylindrical outlet 62 that is configured to be connected to a vacuum source. While the lower blade guard 14 is shown in simplified form, it should be understood that its specific design must be compatible with the motor and drive assembly that permits height adjustment as well as bevel angle adjustment of the blade. In such event, the upper surface of the sidewalls 60 may be required to be spaced from the table top 16 so as to accommodate such bevel orientation of the blade. Additionally, while the riving knife 18 is not shown in any detail, it should be understood that it is mounted in the motor and drive assembly for the blade and is coplanar with the plane of the blade.

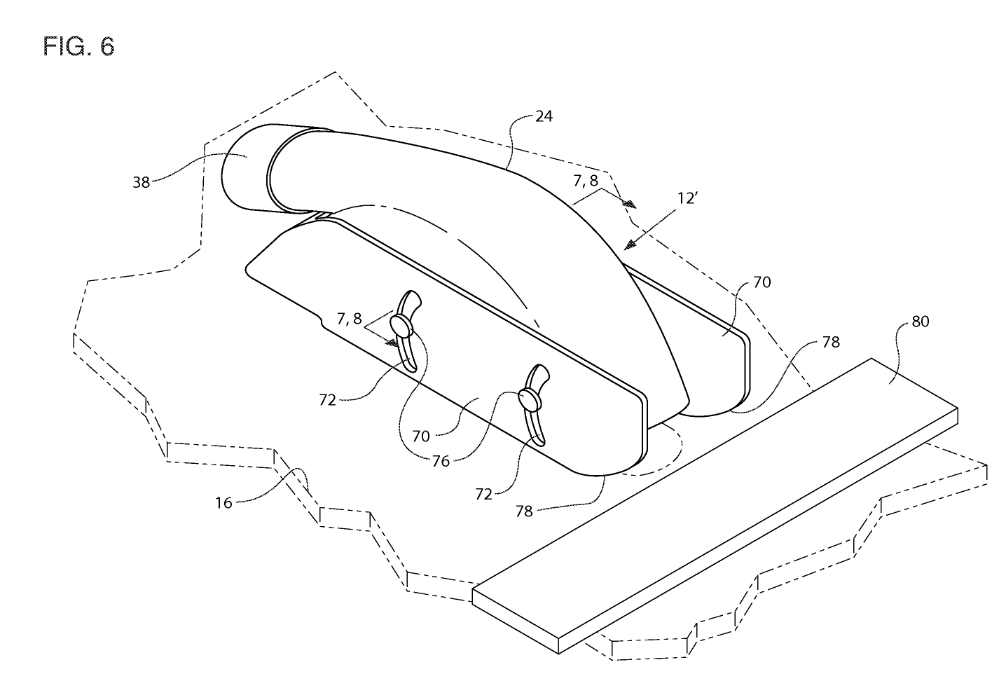

A second preferred embodiment is shown in FIGS. 6, 7 and 8, wherein the same reference numbers are used for components that are similar to the first preferred configuration shown in FIGS. 1-5. Where there is some difference in structure for an otherwise similar component, a prime designation may be added to the number. New structure and/or components are given new reference numbers. The configuration of the upper guard 12′ is substantially similar to the upper blade guard 12 except that it has a pair of side plates 70 that are movably attached to the side walls 44 of the cover guard portion 24.

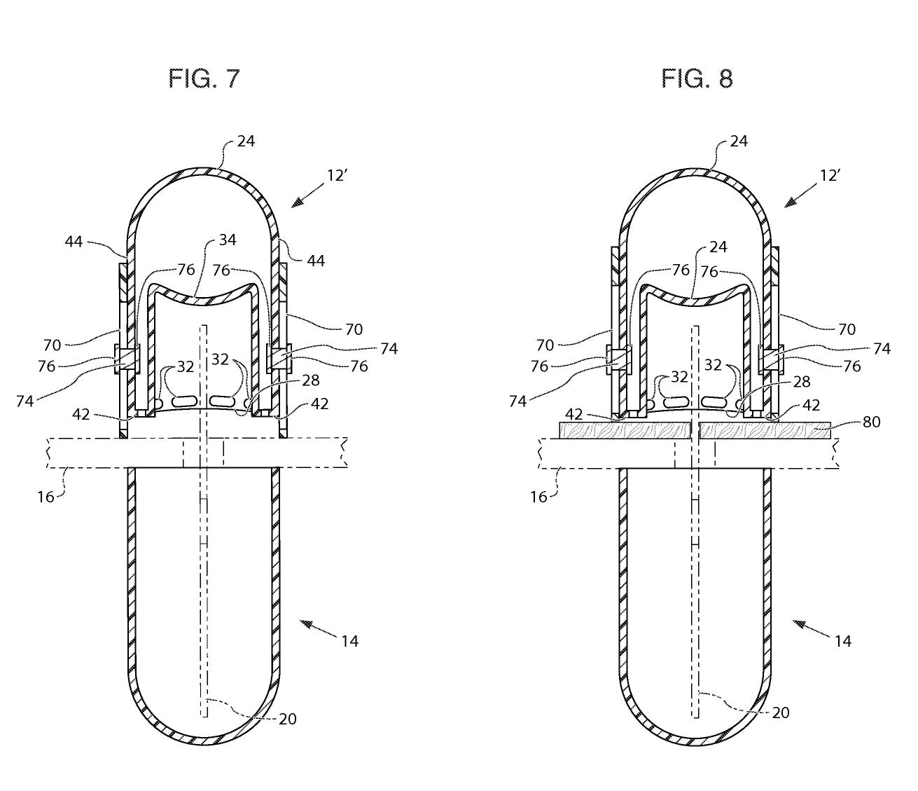

The side plates 70 have a pair of arcuate slots 72 spaced apart from one another in which the connector pins 74 are located, with the pins 74 having enlarged head portions 76. The heads 76 have a larger diameter than the intermediate portion which is sized to slide within the width of the slots 72. The side plates have inclined ramp front portions 78 which are configured to engage a work piece such as the work piece 80 shown in FIG. 6. The side plates are provided to create a barrier to more efficiently apply the suction force to the immediate area of the blade so that diffusion dust and other particular matter can be extracted through the outlets. As shown in FIG. 7, the bottom wall 42 is shown to be spaced away from the table top 16 which may be a design feature that is desired in which case the side plates extend below the elevation of the bottom wall 42 and create a barrier separating the blade area from the area outside of the upper blade guard 12′. It is also desirable to have such side plates in the event that the table saw is one which has an adjustable bevel cutting capability in which case the blade 18 is not vertically oriented as shown in FIGS. 6, 7 and 8, but is angularly adjustable at least in one direction by a considerable angular amount, i.e., up to about 45°. If the blade is oriented at such an angle, it is highly desirable that the side of the upper blade guard 12′ that is moved away from the table top 16 have the side plate move downwardly to create the desired barrier.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention.

Various features of the invention are set forth in the following claims.

What is claimed is:

1. A guard system for a table saw having a top surface with an opening through which a blade extends for cutting a work piece, the forward reach of the cutting edge of the blade engaging the work piece in a downward cutting direction, said system comprising:
an upper guard mounted to said table saw and configured to enclose the blade to shield a user from contacting the blade, said upper guard having an outlet adjacent the rearward reach of the blade for connection to a vacuum source, an inlet adjacent to the forward reach of the blade and to the table top surface and an interior channel communicating said inlet to said outlet.

2. A guard system as defined in claim 1 further comprising a riving knife mounted to the table saw rearwardly of the rearward reach of the blade, said upper guard being mounted to said riving knife.

3. A guard system as defined in claim 1 wherein said upper guard comprises a base guard wall surrounding the blade and a cover guard wall surrounding at least a substantial portion of said base guard wall, and being spaced from said base guard wall at least near said forward reach of the blade and between said inlet and outlet to define said interior channel.

4. A guard system as defined in claim 3 wherein said interior channel extends from said inlet to said outlet and has a substantial flow path adjacent the outer periphery of the blade.

5. A guard system as defined in claim 4 wherein secondary flow paths are defined between said cover guard wall and said base guard wall on opposite sides of the blade adjacent the top surface of the table saw, said secondary flow paths communicating with the exterior of said upper guard through slots in said upper guard adjacent the table top.

6. A guard system as defined in claim 5 wherein there are a plurality of said slots aligned generally parallel to the blade along opposite sides thereof adjacent the table saw top surface.

7. A guard system as defined in claim 5 wherein said inlet comprises at least one front slot adjacent the table top surface.

8. A guard system as defined in claim 3 wherein said base guard wall and said cover guard wall have a releasable pivot connection connecting said upper guard to said riving knife.

9. A guard system as defined in claim 1 wherein said base guard and said cover guard are formed of a generally thin walled transparent strong plastic material.

10. A guard system as defined in claim 1 further comprising a lower guard mounted to said table saw beneath the table top surface and being configured to enclose the lower reaches of the blade and receive dust and fragments from a work piece being cut, said lower guard having an outlet adjacent the rearward reach of the blade for connection to a vacuum source.

11. A guard system as defined in claim 1 further comprising moveable side plates connected to said cover guard and being vertically adjustable to provide an isolating barrier between the bottom surface of said cover guard and the table top surface or a work piece if present.

12. A guard system as defined in claim 11 wherein said side plates have at least two spaced apart generally vertically oriented slots and said cover guard has a connector element that rides in each of said slots, thereby permitting said side plates to move vertically relative to said cover guard.

13. A guard system as defined in claim 1 wherein said outlet has a generally circular configuration for connection to a hose of a vacuum source.

14. A guard system for a table saw having a top surface with an opening through which a rotating circular blade extends for cutting a work piece, the front of the blade normally initially engaging a work piece in a downward cutting direction, the table saw having an upwardly extending riving knife adjacent the back of the blade, said system comprising:
an upper guard mounted to said table saw and configured to enclose the blade to shield a user from contacting the blade, said upper guard having a top portion that extends above the top of the blade, a front portion that extends beyond the front of the blade, a back portion that extends beyond the back of the blade and opposite side portions that extend from said top portion downwardly to an elevation near the table top surface, said top, front, back and side portions substantially enclosing the portion of the blade extending above the table top, said upper guard having an outlet in said back portion for connection to a vacuum source, at least one inlet in said front portion near the table top surface and an interior flow channel extending from said inlet to said outlet.

15. A guard system as defined in claim 14 further comprising a lower guard mounted to said table saw beneath the table top surface and being configured to enclose the portion of the blade below the table top surface and receive saw dust, chips and splinters from a work piece being cut, said lower guard having an outlet adjacent the back of the blade for connection to a vacuum source.

16. A guard system as defined in claim 14 wherein said upper guard further comprises a base guard wall surrounding the blade and a cover guard wall surrounding at least a substantial portion of said base guard wall, and being spaced from said base guard wall in said top portion, front portion and rear portion to define said interior flow channel.

17. A guard system as defined in claim 16 wherein secondary flow paths are defined between said cover guard wall and said base guard wall at the bottom of said side portions adjacent to the top surface of the table saw, said secondary flow paths communicating with the exterior of said upper guard through slots in said side portions adjacent to the table top.

18. A guard system as defined in claim 14 further comprising a moveable side plate connected to each of said side portions and being vertically adjustable to provide an isolating barrier between the bottom surface of said side portions and the table top surface or a work piece if present.

19. A guard system as defined in claim 17 wherein said side plates have at least two spaced apart generally vertically oriented slots and said cover guard has a connector element that rides in each of said slots, thereby permitting said side plates to move vertically relative to said cover guard.
